(19) United States
(12) Patent Application Publication
(10) Pub. No.: US 2022/0353143 A1
(43) Pub. Date: Nov. 3, 2022

(54) INJECTING CONTROLLED NETWORK FAILURES USING IN-SITU OAM AND OTHER TECHNIQUES

(71) Applicant: Cisco Technology, Inc., San Jose, CA (US)

(72) Inventors: Craig Thomas Hill, Sterling, VA (US); Cesar Obediente, Apex, NC (US)

(21) Appl. No.: 17/243,740

(22) Filed: Apr. 29, 2021

(51) Int. Cl. H04L 12/24

(52) U.S. Cl. CPC H04L 41/0836; H04L 41/147; H04L 41/0813

(57) ABSTRACT

A network controller is configured to control a plurality of network devices in a network. The network controller generates one or more commands that are configured to inject a failure to propagate through two or more network devices in the network. The network controller provides the one or more commands to at least one of the two or more network devices to initiate the failure. The one or more commands cause the failure cause the two or more network devices to collect and propagate telemetry data, on a hop-by-hop basis. The network controller obtains the telemetry data collected from the two or more network devices, and analyzes the telemetry data to determine an impact in the network of the failure propagated through the two or more network devices.

### TECHNICAL FIELD

The present disclosure relates to networking.

### BACKGROUND

Network users across every sector (enterprise, government, service provider, financial, etc.) are looking for ways to maintain serviceability and uptime at the highest possible levels while providing a solid network foundation to better serve applications. These networks are becoming more complex to architect, operate, and maintain because of their vast global footprint combined with a shift to co-location centers and public clouds. In addition, many customers are leveraging multi-tenancy to comply with security regulations, while implementing overlay technologies like Virtual Extensible Local Area Network-Ethernet Virtual Private Network (VXLAN-EVPN) and backbone transports such as Segment Routing, further adding layers and network points within the data networks.

Either due to failures (hardware/software) of the network's elements, links, or through human errors of network operators, network equipment does not have the tools or applications to help network operators understand proactively the impact a failure would have at any level. These failures could consist of any combination of links, nodes, congestion, buffer over-flows, or the complex brown-out scenario, and network operators lack the capabilities to simulate these network failures, and do this proactively with a defined workflow to proactively determine the potential effect of such events on the data network and applications.

### BRIEF DESCRIPTION OF THE DRAWINGS

FIG. 1 is a block diagram of a network environment that is configured to perform failure injection and analysis, according to an example embodiment.

FIG. 2 is a diagram depicting a general operational flow of the failure injection and analysis techniques, according to an example embodiment.

FIG. 3 is a diagram depicting an operational flow that leverages in-Situ Operations Administration and Management (iOAM) for failure injection and failure data collection, according to an example embodiment.

FIG. 4 is a diagram depicting an example of a simplified network in which iOAM is used for failure injection and failure data collection, according to an example embodiment.

FIG. 5 is a diagram depicting an interaction between a network controller and a network device for configuring a failure probe function on the network device, according to an example embodiment.

FIG. 6 is a flow chart depicting a method for network failure injection and analysis, according to an example embodiment.

FIG. 7 is a hardware block diagram of computing device that may be configured to perform the functions of a network controller in the context of the network failure injection and analysis presented herein, according to an example embodiment.

### DESCRIPTION OF EXAMPLE EMBODIMENTS

### Overview

Presented herein are embodiments for performing failure injection and analysis in a network to simulate the behavior of one or more failures in the network. A network controller is provided that is configured to control a plurality of network devices in the network. The network controller generates one or more commands that are configured to inject a failure to propagate through two or more network devices of the plurality of network devices in the network. The network controller provides the one or more commands to at least one of the two or more network devices to initiate the failure. The one or more commands cause the failure to propagate through the two or more network devices and cause the two or more network devices to collect and propagate telemetry data, on a hop-by-hop basis, from the two or more network devices as the failure propagates through a network path that includes the two or more network devices. The network controller obtains the telemetry data collected from the two or more network devices, and analyzes the telemetry data to determine an impact in the network of the failure propagated through the two or more network devices.

### EXAMPLE EMBODIMENTS

In the last few years, networks and applications have seen a tremendous increase in complexity because of the way they are being built across multiple clouds providers (hybrid, public and private), different tiers, and moreover, the Internet has become the new transport where users are connecting to the applications. Network users have thousands of network devices including routers, switches firewalls, load-balancers, etc. Unfortunately, networks and applications will fail due to software or hardware issues, but they can also fail because of configuration errors (human errors). Network failures are expected but the results are extremely unpredictable.

Network users are looking for ways to introduce network failures to proactively understand and pre-determine/predict how networks will react when these outage occurs. The ability to predetermine or “simulate” network outages, network users can re-design around these predetermined failures and prevent the unexpected outcomes of these outages in order to minimize the impact to the applications. This will help network users to determine how redundancy has been built in the network and/or applications and what changes can be added to the overall design to limit (or eliminate) the impact and downtime.

Thus, a network mechanism that can proactively simulate network failures by injecting such events into the network can help network users to build and configure more resilient networks and minimize downtime. Accordingly, a mechanism is presented herein by which a network operator (manually or through automation) may inject a broad set of network failure(s) within the network (e.g. devices, links, regions, cloud providers) so that a network operations teams can proactively understand how the network will react for any type of failure defined, allowing network operators and architects to design around the failures proactively ahead of time, enhancing the overall network uptime and enhancements to pin-point exactly the network needs to be optimized. This will also limit over-engineering while adding the deterministic behavior useful for any minor to catastrophic failures that can occur, and which can eliminate surprise effects of those failures for the operations teams.

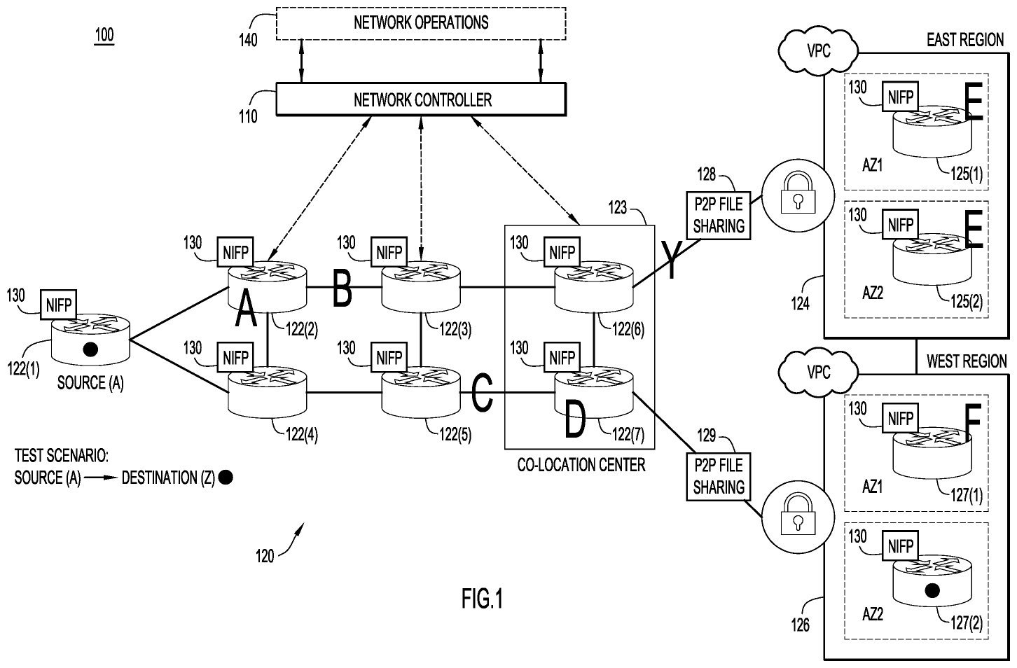

Reference is now made to FIG. 1. FIG. 1 shows a system 100 that includes a network controller 110 that configures and controls network devices in a network 120. In the example shown in FIG. 1, the network 120 includes a plurality of network devices (routers) 122(1), 122(2), 122(3), 122(4), and 122(5) as well as network devices 122(6) and 122(7) in a co-location center 123. The network 120 also includes two additional regional network portions 124 and 126. Regional network portion 124 (referred to as the East Region) includes network devices (routers) 125(1) and 125(2) and regional network portion 126 (referred to as the West Region) includes network devices (routers) 127(1) and 127(2). As an example, there is a secure Peer-to-Peer (P2P) file sharing protocol network connection 128 between the network device 122(6) and the regional network portion 124. Furthermore, the network devices 125(1) and 125(2) are configured with a shared pool resource technology, such as Virtual Port Channel (VPC). Similarly, the network device 122(7) is connected via a P2P file sharing protocol network connection 129 to the regional network portion 126. Moreover, the network devices 127(1) and 127(2) are configured with VPC.

As shown in FIG. 1, there is a network injection failure probe (NIFP) 130 embedded in each of the network devices in the network 120. These probes may be embodied as software agents and are configured to have communication to the network controller 110 to receive commands that introduce different types of network failures such as link failure, link load, etc. After completion of the failure task, the NIFPs 130 report back to the network controller the results for the network operations team 140 to understand and comprehend the potential impact of such a failure.

The network controller 110 may determine how to better prepare for unplanned networks outages. In one embodiment, the network controller 110 and the NIFPs 130 may be configured to use in-Situ Operations Administration and Maintenance (iOAM) to propagate relevant network failure information as these induced failures/errors occur.

The network controller 110 and NIFPs 130 are configured to provide a framework for injecting a broad spectrum of network failures to better serve network operators in determining in more detail the impact a failure will have in the data network. Furthermore, this includes support for multi-tenancy as well as overlay technologies such as VXLAN-EVPN, Generic Routing Encapsulation (GRE) protocol, and rapidly evolving Segment Routing, to allow the operators to run tests on both the overlay and underlay of network architectures where they apply. The system 100 may be employed for a simulation environment as well as in an actual deployed network environment.

FIG. 1 illustrates, by letters A—F, and Y, examples of failure scenarios. In addition, FIG. 1 shows a test path scenario between a source (network device 122(1) denoted node A) and a destination (network device 127(2) denoted Dest(Z) in regional network portion 126)).

A. Node Failure

B. Link Failure

C. Disabled Encryption

D. Failure of Co-Located Routers

E. Failure of Virtual Router in Cloud VPC

F. Failure of path A-Z

Y. MTU/Fragmentation failure on P2P File Sharing Connection 128.

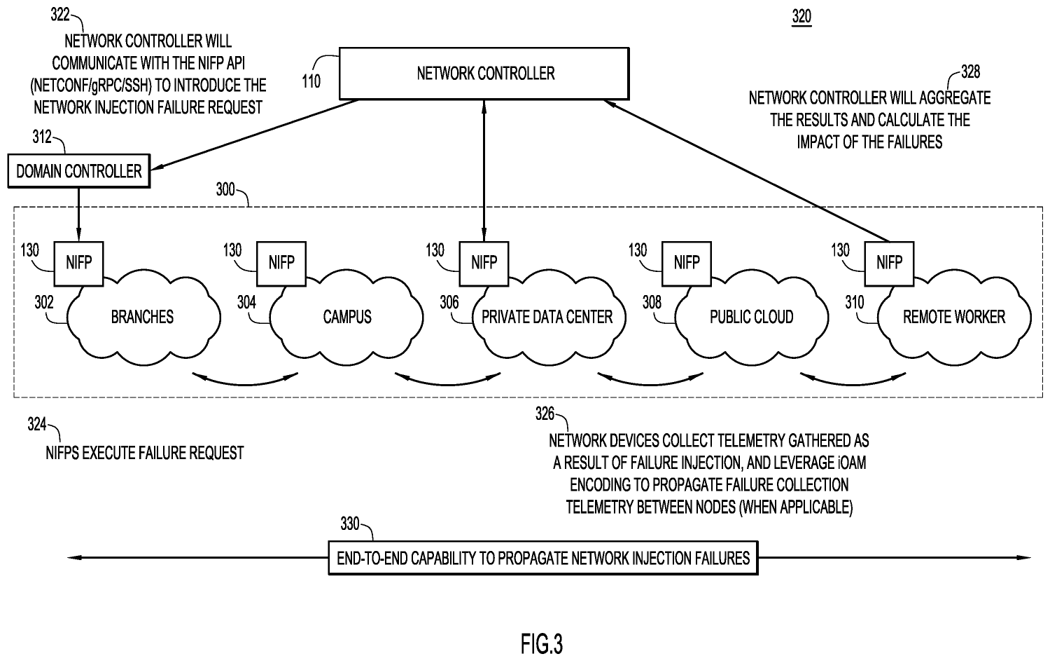

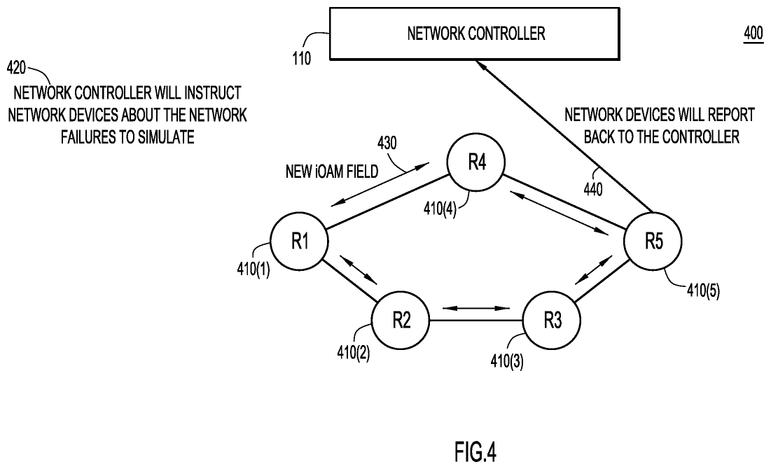

iOAM may be employed to help network operators in providing measurements around performance and metrics of the network. The embodiments presented herein enhance iOAM to introduce network injection failures for an end-to-end network path, as will be described in more detail below in connection with FIGS. 3 and 4.

However, out-of-band transport protocols may be used to convey failure data to the network controller 110. Examples of such out-of-band transport protocols include the Transmission Control Protocol (TCP) or Remote Procedure Call (gRPC) protocol. In some cases, a network operator may desire to transport all of the failure output via telemetry gathered out-of-band to the network controller 110. For example, in a massive link failure test, an operator would not want to lose or disrupt the telemetry collection that is intended on being sent to the network controller 110 for further analysis. Without this option, valuable data gathered could be lost in the test failure workflow, in turn providing inaccurate results.

The network controller 110 may define different categories of failures to be simulated/tested based on the location and functionality of the network devices. The following are examples of possible categories of failures.

Within a Domain: A network operator may inject failures via the network controller within a specific area of the network i.e., Campus, Data Center, Branch, etc. This scenario could cover one or multiple network devices (routers, switches, Network Function Virtualization (NFV), etc.).

Device (Node) Failures. The NIFPs 130 will handle the injection failures related with power cycle, line card failures (supervisor, fabric modules, line cards, etc.), port failures, power supplies, memory, central processing unit (CPU), hard drive, and more generally anything physical to the network device that could potentially fail.

Link Failures. Creating a failure associated with in-band/network traffic has the ability to inject network failures. These network failures may be related to traffic errors, traffic capacity loads, maximum transmission unit (MTU), fragmentation, etc. With reference to FIG. 1, link failure B may involve testing load on the link in terms of Quality of Service (QoS) and/or capacity, packet errors in terms of testing Internal Gateway Protocol/Border Gateway Protocol (IGP/BGP) flapping protection, and frame errors. Link failure C may involve disabled encryption. Link failure E may involve may involve failure of both network devices 125(1) and 125(2) configured for VPC and thus diversion to the network regional portion 126 should occur. Failure F is a failure of an availability zone that should result in a diverting to the backup. Link failure Y may involve MTU/fragmentation.

Overlay Network (e.g., VXLAN) Failures. The NIFPs 130 may inject overlay network (e.g., VXLAN) failures such as removing virtual tunneling endpoint (VTEP) addresses, deleting Route Reflector for Multi-Protocol (MP) BGP EVPN, affecting virtual network identifier (VNI) forwarding such as deleting an Anycast Gateway, removing virtual router forwarder (VRF) components, etc.

Domain Name System (DNS) Failures. The NIFPs 130 may inject DNS failures by changing routing to the DNS server(s) or creating several DNS requests to cause overload in the DNS server.

Within a Network Technology: The network operator may inject network failures based on network technologies.

Specific Encapsulation Failures. Use iOAM frame formats to provoke failures in multi-tenant and overlay technologies, such as VXLAN-EVPN and Segment Routing.

Specific Routing Protocol Failures. The NIFPs 130 may introduce failures scenarios with regards to routing protocols. These routing protocol failures may be database corruption, neighbor failures, adjacencies failures, next hop failures, etc.

Storage Area Network (SAN) Failures. The NIFPs 130 may inject SAN failures. These failures could be traffic storage traffic load, shutting down SAN ports, wrong World Wide Name (WWN), Logical Unit Number (LUN), etc.

Server Load Balancer (SLB) Failures: The NIFPs 130 may introduce failures by poisoning Virtual Internet Protocol (VIP) addresses to black-hole traffic and create traffic load to the VIP addresses to test the load in the virtual and real servers.

Security Failures. Security devices running the NIFPs 130 can inject failures such as removing encryption keys, removal of VPN IP addresses, security peering to other devices, sending traffic load to devices.

NFV Failures. The NIFPs 130 may inject failures to a hypervisor, container, virtual machine (VM), etc.

Within a Region: A vast majority of network operators have multiple regions within their environment. The network controller 110 can induce failures in specific regions.

Private Region. Load and/or fail regional links.

Carrier Neutral Facility (CNF). Induce failover CNF and provide a mechanism to load and/or fail links.

Inter Region. Organizations are more global than ever before and applications are spread across multiple countries for redundancy but also for governance compliance. This scenario will allow the operator to create performance network failures in different country/regions.

Inter-Country. This injection will provide the ability to load and/or fail intercontinental links.

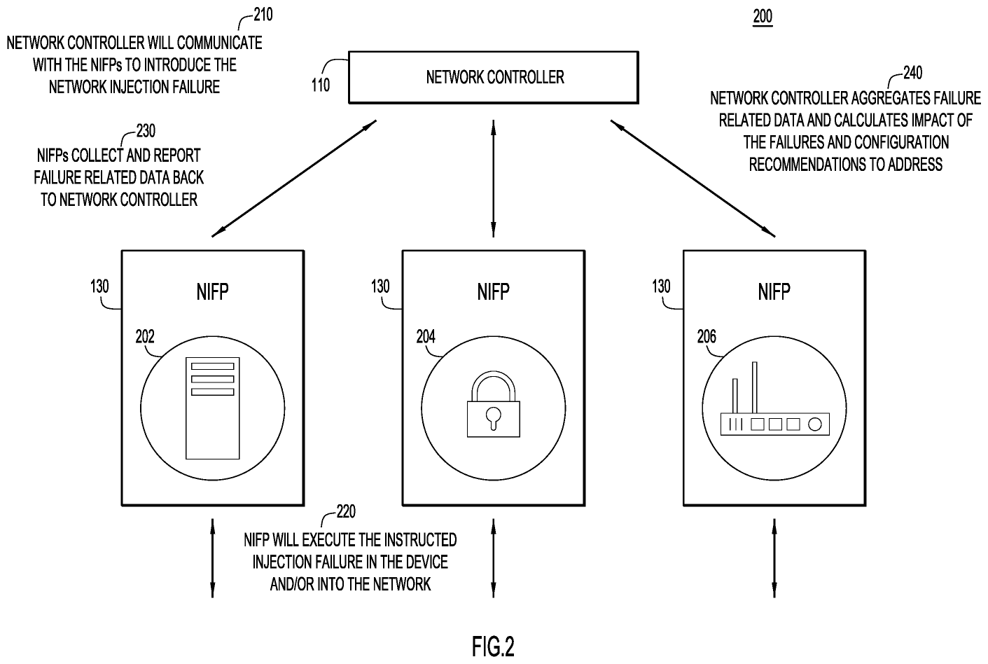

Reference is now made to FIG. 2. FIG. 2 shows a high-level representation of an operational flow 200 between the network controller 110 and the NIFPs 130. There is an NIFP 130 installed and running on a storage node 202, an NIFP 130 installed and running on a firewall 204 and a NIFP 130 installed and running on an access point (AP) 206, as an example.

At 210, the network controller 110 communicates with the NIFPs 130 to introduce the network injection failure. At 220, the NIFPs 130 execute the instructed injection failure in the network device and/or into the network. At 230, the NIFPs 130 collect resulting failure related data and report it back to the network controller 110. At 240, the network controller 110 aggregates the failure related data and calculates impact of the failures as well as produces configuration recommendations to address the failures.

iOAM has the ability to gather telemetry and other types of information along a network path within the data packet. This is done on a hop-by-hop basis where iOAM is able to collect a variety of information about the nodes in the path including path tracing, path verification, service level agreement (SLA) including parameters such as delay, jitter, and packet loss, etc.

An enhancement to iOAM is presented herein, in which the networking equipment, in-band of traffic, injects network failures to generate simulated failures to a network and/or simulate an end-to-end failures scenario(s). This enhancement will include the ability to simulate network outages to proactively understand the consequences that could occur in such event. Reference is now made to FIG. 3. In FIG. 3, a network environment 300 is shown that includes one or more branches 302, a campus 304, a private data center 306, a public cloud 308 and a remote worker 310. There is a domain controller 312 between the network controller 110 and the branches 302. An operational flow 320 involving use of iOAM according to the techniques presented herein is now described.

At 322, the network controller 110 communicates with the NIFPs using, for example, an Application Programming Interface (API) such as NetConf/gPRC/Secure Shell (SSH) protocol, to introduce the network injection failure request. In one form, the network controller 110 communicates via the domain controller 312 with a NIFP running on a network device in the network 300, such as in the one or more branches 302. The domain controller 312 in turn relays the commands from the network controller 110 to the NIFP 130 running in the branches 302. In other forms, the network controller 110 communicates directly with the NIFPs 130, as shown in FIG. 3.

At 324, the NIFPs 130 execute the failure request. At 326, the NIFPs 130 in the network 300 collect the telemetry gathered as a result of the failure injection, and leverage iOAM encoding to propagate the failure collection telemetry between nodes (when applicable). At 328, the network controller 110 collects the failure telemetry via iOAM and aggregates the failure telemetry to determine the impact of the failures. Thus, as shown at 330, iOAM involves end-to-end iOAM capability to propagate network injection failures.

FIG. 4 illustrates the use of iOAM in another manner, for a simplified network environment 400 that includes network devices R1-R5 shown at reference numerals 410(1)-410(5). In this example, the network operator may be running the VXLAN overlay technology in their environment. At 420, the network controller instructs the network devices 410(1)-410(5) about the network failure to simulate. For example, a network operator may determine the failure that to introduce to the network, such as introduce a load test from R1-R5 using two paths. Thus, at 420, the network controller 110 instructs the network devices to start simulating the network failure by leveraging new iOAM fields.

The network devices 410(1)-410(5) propagate failure telemetry data resulting from the failure in a new iOAM field 430 on a hop-by-hop basis. The network devices 410(1)-410(5) will start the process of injecting network failures. At 440, the network devices report the collected failure telemetry to the network controller 110. For example, using an out-of-band mechanism, the network devices 410(1)-410(5) will report back to the network controller 110 via gRPC or TCP to ensure the network is not loaded with unwanted traffic. The network controller computes the results from the network devices and provides result metrics, and/or network configuration changes.

A new set of network failure injection type, length value (TLV) fields are added to the iOAM protocol to enable the techniques presented herein. In order to address the different functions and place in the network (PIN) devices, the following TLVs may be added.

1) iOAM for single network device failures: This new TLV of the iOAM protocol is used to simulate network failures for a particular network device (node), including those described above, such as power supply failure, hard drive failure, etc.

2) iOAM for link failures: This new TLV provides the necessary fields to the iOAM protocol to simulate network failures across a predetermined network path or link, including those described above, such as routing protocol failures, encapsulation failures, etc. This new TLV may be used to inject network failures across multiple domains, regions, cloud providers, etc. The intent is to use iOAM with the new TLV to introduce network failures and report back on a hop-by-hop basis.

Many of the use cases highlighted in the IETF draft “Requirements for In-situ OAM draft-brockners-inband-oam-requirements-03 may be employed by the techniques presented herein.

The iOAM type to be recorded includes: edge-to-edge, selected hop, and per hop, where statistics can be gathered at each hop and correlated as an iOAM packet traverses the network. For example, the “type” collection fields may be modified to define if the collection for a specific test was “edge-to-edge”, or relegated to a single node (e.g., a specific hop). As an example, an operator desires the capability to inspect and verify the health of an encryption path across multiple nodes within the network (multiple hops). In this use case test, the “type” field would indicate “edge-to-edge”, and an additional “trace-type” attribute may also be defined for more explicit attributes needed for this specific test. Examples of newly defined attributes may indicate the level of encryption being used, the level and strength of the encryption ciphers, security association key size, etc. An ML/AI application may leverage this “post-collection” telemetry to execute comparison tests to identify which attributes fall in and out of compliance for the target security threshold defined in a user policy. This use case is defined as a “collection” use case, but leveraging newly defined attribute extensions to the existing iOAM standards, will offer an entirely new set of capabilities and use cases including immediate “detect and correct” capabilities, where immediate configuration changes can be applied if a set of attributes are not in compliance per the comparison policy.

New TLV Trace-Type Options may be added to examples already defined in Section 8.2 of Data Fields for In-situ OAM draft-ietf-ippm-ioam-data-11, including adding to the iOAM Option-type registry for each bit allocation, etc.

Examples that may involve new option-type registries include:

Load on a link, generated from the NIFPs.

Fragmentation generation and collection. This example simulates fragmentation and the need for re-assembly, and impact of that re-assembly process on the receiving node. One example may be the case of a GRE tunnel, where re-assembly is required on the router, not on the destination host.

Encryption use cases for simulated man-in-the-middle from the NIFPs.

Invalid re-key sequence (pre-shared key) for Media Access Control (MAC) Security (MACsec), and the simulation from the NIFP and behavior collection of the remote peer node assuring the link is not passing traffic in the clear.

While one use involves a “collection” of failure injection observations/results, the newly defined attribute extensions to the existing iOAM standards offer an entirely new set of capabilities and use cases that target a more real-time response referred to as “detect and correct”, where configuration changes can be applied if a set of attributes that are analyzed are not in compliance with a desired policy. In this example of “detect and correct”, consider the end-to-end data collection via iOAM has been completed, a compare/contrast process may be immediately executed with the collected telemetry against existing configuration state attributes (for example, the format of the configuration and parameters would be in a uniform YANG model format). Any configuration differences would be reported to the network controller, triggering a desired configuration change on each network element (via an API) that assures the security configuration and attributes are compliant with the desired state. This is an example of real-time scenarios that may be provided, creating a “closed-loop” process of 1) collect, 2) compare, and 3) automate configuration changes to desired state.

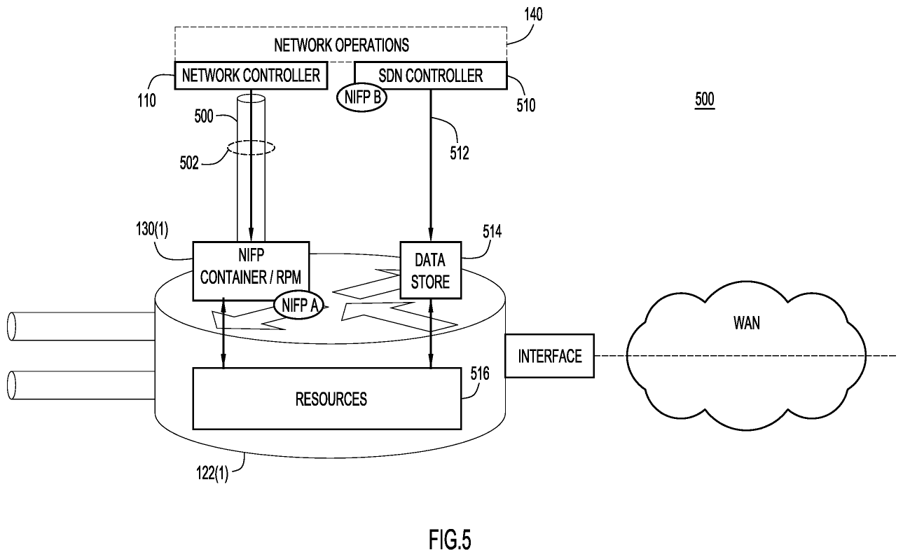

Connectivity between the network controller 110 and a network device 122(1) is now described in more detail with reference to FIG. 5. The transport mechanism 500 between the network controller 110 could vary, and includes, for example, NetConf, gRPC, etc. The network controller 110 and the NIFP 130 running on the network device cooperate to simulate a network outage. The network device 122(1) is a router, for example. The network controller 110 may create and maintain a secure control channel 502 using, for example, the Transport Layer Security (TLS) protocol. This is important because a level of security should be maintained in the network to guarantee the Chaos Network Controller is the only device capable of initiating the chaos, much like a master/slave relationship. A Software Defined Networking (SDN) controller 510 may also have connectivity to the network device 122(1) via a transport mechanism 512 to a data store 514 on the network device 122(1). Thus, the network device 122(1) more generally includes resources 516 (CPU, memory, power supply, etc.) of which the data store 514 may be a part.

The network device 122(1) has an NIFP 130(1) installed thereon. The NIFP 130(1) can run as a container or as a Red Hat Package Manager (RPM) depending on its capability. The NIFP software is only downloadable from the network controller 110. A digital signature may be created to guarantee authenticity of the software and then, before every start of the network controller 110, a digital certificate will be created between the network device 120(1) and the NIFP 130(1). This will provide a level of security to guarantee that the process has been initiated by the (authentic) network controller 110, to avoid any malicious attack.

A first certificate, denoted NIFP A, may be used for integrity of the secure control channel 502 from the network controller 110 to the NIFP 130(1) embodied as a container on the network device 122(1). A second certificate, denoted NIFP B, may be used for integrity of communications between the network controller 110 and the SDN controller 510. This allows the network controller 110 to use a network operations controller, SDN controller 510, already in place for basic functions for workflows already present in the network device 122(1), such as shut interface, shut process, generic iOAM, etc.

For iOAM enhancement, a similar process will take place in which a network operator may configure the network controller 110 with information to obtain the digital signature. The network device 122(1) downloads the necessary information to create the secure control channel 502 between the network controller 110 and the NIFP 130(1).

The following is an example of the secure channel negotiation.

Installation of the NIFP:

1. User logs to the into the network controller 110.

2. User onboards network devices, manual input, API, etc.

3. The network controller creates a unique signature for the newly added device.

4. The network controller starts the downloading process of the NIFP (container or RPM) which includes the unique signature, such as via gRPC, Netconf, API, etc.

5. After downloaded has completed, the installation process for the NIFP software starts.

6. After installation has been completed, the NIFP triggers a registration process to the network controller that includes the unique signature that was provided in the NIFP software.

7. The network controller receives the registration request from the NIFP process and verifies the authenticity of the NIFP.

If the signature matches, the network controller 110 will bring up the secure control channel 502. Otherwise, the network controller will delete the NIFP software from the network device.

Starting the Signaling Failure Injection Process:

1. The network controller 110 instructs the NIFP process to start the failure injection.

2. The network controller 110 sends a digital certificate with an expiration time that matches the network devices to instruct the NIFP to start a failure injection process.

3. The NIFP process will check the authenticity of the digital certificate.

4. If authenticity is true, the NIFP process is started. Otherwise, it is ignored.

The embodiments presented herein may be used in a lab “shadow” environment or in production/actual network environments, to simulate network failures in order to determine the consequences of the application with regards to “user-to-network-to-app”. Again, these techniques enable the simulation of a broad set of network outages (i.e., single, combination of outages) regardless if the network is simulated, or live.

Failure Example 1: Common DNS failure

A network operator desires to trigger a DNS failure. The network controller 110 can instruct the network devices in the network to create a DNS iOAM packet that intercepts the actual DNS packet and drop. Alternatively, the network controller 110 can instruct the network devices to change the routing table for the DNS destination.

Failure Example 2: Simulating the fragmentation of a packet and the impact on the receiving router when the router is responsible for re-assembly (e.g., in the case of GRE tunnel between two routers).

The NIFP injects a source of the GRE tunnel header, in a packet size (MTU) far exceeding the MTU of the data path, causing a fragmented packet to be sent. The receiving router (GRE tunnel endpoint) receives the fragmented packet, destined for it. The receiving router performs the re-assembly function of the fragmented GRE packets, and iOAM is able to record the impact on the CPU performance of the taxing re-assembly process, and also records if re-assembly packets were punted and/or dropped by the control-plane policing mechanism in the router (handling different per platform). GRE re-assembly is a known, common, and disruptive function in networks and by leveraging the techniques presented herein with iOAM enhancements, the results are can be propagated through the network to the collection point. This MTU test can be leveraged in links, as well as in overlay encapsulations.

Failure Example 3: Encryption MACsec to Certificate Authority or Registration Authority (RA) Connection Lost

The network operator desires to trigger a failure for links/nodes running MACsec specifically around certificate and key exchange. The network controller can instruct the network device to create a MACsec iOAM packet configured do the following:

1. Delete the path to the certificate authority (CA) server.

2. Block Hypertext Transfer Protocol (HTTP) traffic to the CA server the event the network devices are using Simple Certificate Enrollment Protocol (SCEP).

3. MACsec iOAM can block HTTP directly in the network device.

4. MACsec iOAM can trigger an HTTP failure in the path from source MACsec device to the CA, and then iOAM can provide the entire path and determine the side effects of such a failure. This could help an operator to understand single point of failures in the network.

5. Remove manual certification.

The selection of a particular failure can be chosen and executed via APIs or a command line interface (CLI). Additionally, the selection of a failure scenario is assumed to be the choice of a “single failure”, or where multiple failures are desired (serially or in parallel), it is assumed a “failure workflow” would be constructed and injected. In either case, with these unique extensions to iOAM, the network operator will have the ability to propagate “failure injections” commands in-line, or leverage these unique extensions in iOAM to holistically collect important data collected (per hop) from the failure scenarios.

It is to be understood that the embodiments presented herein contemplate the introduction of one or more failures and the ability to recover the network from the one or more failures. This can be done via out-of-band management. The system will keep track of the failure scenarios being executed and have the ability to completely “back-off” or “roll-back” in certain catastrophic scenarios.

The techniques presented herein involve injecting failures as well as “collecting” the repercussions of those failures up to the network controller, in order to generate real-time and time-trending telemetry from the failure(s). The collection of the failure repercussions, together with iOAM and the iOAM extensions presented herewith, help provide more extensible capabilities for collection and then the ability to propagate this generation (and collection) of output from the injected failures. Additionally, the system will have the capability to generate reports and provide a “back-off” mechanism for network operators as they desire. Furthermore, the system can incorporate any machine learning/artificial intelligence (ML/AI) mechanisms to discover and build network topologies either through the network controller, or through the APIs that are exposed by the network controller, or both.

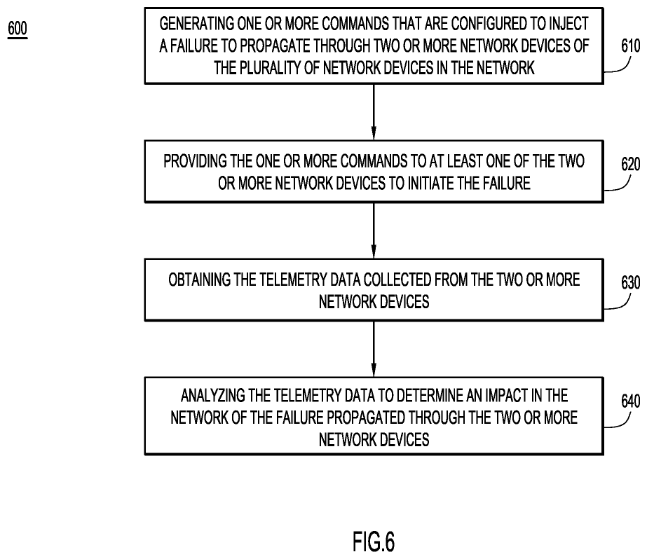

Reference is now made to FIG. 6, which illustrates a flow chart of a method 600 performed by a network controller, e.g., network controller 110, depicted in FIGS. 1-5, according to an example embodiment. As described above, the network controller 110 is configured to control a plurality of network devices in a network. At operation 610, the network controller generates one or more commands that are configured to inject a failure to propagate through two or more network devices of the plurality of network devices in the network. At operation 620, the network controller provides the one or more commands to at least one of the two or more network devices to initiate the failure. The one or more commands cause the failure to propagate through the two or more network devices and cause the two or more network devices to collect and propagate telemetry data, on a hop-by-hop basis, from the two or more network devices as the failure propagates through a network path that includes the two or more network devices. At operation 630, the network controller obtains the telemetry data collected from the two or more network devices. At 640, the network controller analyzes the telemetry data to determine an impact in the network of the failure propagated through the two or more network devices.

As described above, the network controller may determine to change a configuration of one or more of the plurality of network devices based on the analyzing of the telemetry data.

The one or more commands may be configured to inject the failure through the two or more network devices that are in an end-to-end network path between a source node and a destination node in the network. In another form, the one or more commands are configured to inject the failure within a specific area or domain, within a specific region of multiple regions, and within an inter country region spanning two or more countries.

The failures may take on a variety of types, as described above. In one example, the failure is a network device failure, including a failure of any physical component on the network device that can fail, including failure of one or more of: a line card, a port, a power supply, memory, central processing unit, and hard drive. In another example, the failure is a link failure including one or more of: a traffic error, a traffic capacity load, a maximum transmission unit (MTU) size, and a fragmentation error. In still another example, the failure is a Virtual Extensible Local Area Network (VXLAN) failure including one or more of: removing virtual tunneling endpoint (VTEP) addresses, deleting a Route Reflector, virtual network identifier (VNI) forwarding functions including deleting Anycast gateway, and removing virtual routing.

In yet another example, the failure is a Domain Name System (DNS) failure including one or more of: changing routing to a DNS server, creating several DNS requests to cause overload of the DNS server. In still another example, failure is related to a networking technology including one or more of: an encapsulation error; a routing protocol error including database corruption, neighbor failure, adjacency failure, and next hop failure; and Storage Area Network (SAN) protocol failure including storage traffic load, shut down of SAN ports, wrong World Wide Name (WWN), and wrong Logical Unit Number (LUN). In still another example, the failure is related to network security functionality including one or more of: removal of an encryption key, removal of virtual private network (VPN) IP addresses, and failure of security peering to other devices.

The operation 610 of one or more commands generating one or more commands may involve generating one or more commands comprises specifying values in one or more fields using the in-Situ Operations Administration and Maintenance (iOAM) protocol to indicate the one or more commands provided to the two or more network devices to simulate the failure across the network path.

The operation 630 of obtaining the telemetry data may be performed from network traffic populated with the telemetry data as the failure is propagated through the network path. In another form, the operation 630 of obtaining the telemetry data may be performed via a separate out-of-band communication to the network controller from the two or more network devices.

In summary, embodiments presented herein enable network operators to inject a deterministic and controlled set of chaos into the network, whether it be a test network or subset of controlled errors/failures in a live network. Chaos may be defined as (1) a state of utter confusion, and the techniques to provide a detailed and controlled ability to network operators to obtain proactive insight on the impact of broad set of failures. Organizations can benefit from an understanding of how the network and application will react when various outages or failures occur in the network. An enhancement to iOAM will provide operators the necessary command and controls as well as telemetry collection to determine how failures could occur, proactively in their network, and leverage this vital information to prevent these failures in the future.

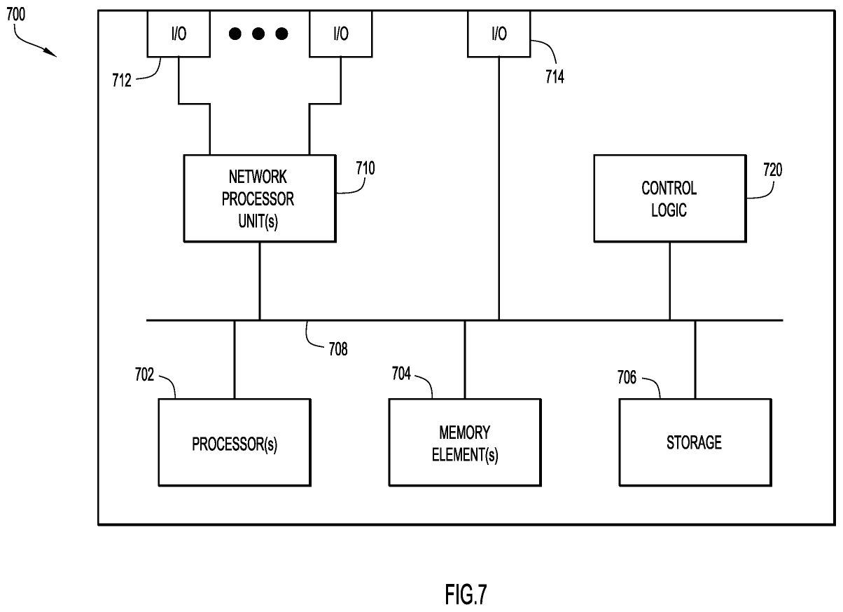

Referring to FIG. 7, FIG. 7 illustrates a hardware block diagram of a computing/computer device 700 or in general any apparatus that may perform functions of the network controller 110 described herein in connection with FIGS. 1-6. Moreover, the hardware block diagram in FIG. 7 may also be generally representative of an apparatus, such as network device that is controlled, according to the techniques presented herein, to induce a failure in the network.

In at least one embodiment, the computing device 700 (an apparatus) may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computer device 700. For example, I/O interface(s) 714 may provide a connection to external devices such as a keyboard, keypad, a touch screen, and/or any other suitable input and/or output device now known or hereafter developed. This may be the case, in particular, when the computer device 700 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor or a display screen.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any apparatus of entity as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts. [moo] As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

[owl] Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In one form, a computer-implemented method comprising: at a network controller that is configured to control a plurality of network devices in a network, generating one or more commands that are configured to inject a failure to propagate through two or more network devices of the plurality of network devices in the network; providing the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices; obtaining the telemetry data collected from the two or more network devices; and analyzing the telemetry data to determine an impact in the network of the failure propagated through the two or more network devices.

In another form, an apparatus is provided comprising: a network interface that performs network communications, including communications with network devices in a network; a memory; one or more processors coupled to the network interface and the memory, the one or more processors configured to perform operations including: generating one or more commands that are configured to inject a failure to propagate through two or more network devices of a plurality of network devices in the network; providing the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices; obtaining the telemetry data collected from the two or more network devices; and analyzing the telemetry data to determine an impact in the network of the failure propagated through the two or more network devices.

In another form, a system is provided comprising: a plurality of network devices in a network, each of the plurality of network devices configured with a failure probe function; and a network controller configured to be in communication with the plurality of network devices, the network controller configured to: generate one or more commands that are configured to inject a failure to propagate through two or more network devices of the plurality of network devices in the network; provide the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices; obtain the telemetry data collected from the two or more network devices; and analyze the telemetry data to determine an impact in the network of the failure propagated through the two or more network devices.

In still another form, one or more non-transitory computer readable storage media are provided, encoded with software instructions that, when executed by a processor of a network controller that is configured to control a plurality of network devices in a network, cause the processor to perform operations including: generating one or more commands that are configured to inject a failure to propagate through two or more network devices of the plurality of network devices in the network; providing the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices; obtaining the telemetry data collected from the two or more network devices; and analyzing the telemetry data to determine an impact in the network of the failure propagated through the two or more network devices.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A computer-implemented method comprising:
at a network controller that is configured to control a plurality of network devices in a network, generating one or more commands that are configured to inject a failure to propagate through two or more network devices of the plurality of network devices in the network;
providing the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices;
obtaining the telemetry data collected from the two or more network devices; and
analyzing the telemetry data to determine an impact in the network of the failure propagated through the two or more network devices,
wherein generating the one or more commands comprises specifying a collection type in a collection type field of an in-Situ Operations Administration and Maintenance (iOAM) protocol as one of end-to-end network path collection and single node collection.

2. The method of claim 1, wherein the one or more commands are configured to inject the failure through the two or more network devices that are in an end-to-end network path between a source node and a destination node in the network.

3. The method of claim 1, wherein the one or more commands are configured to inject the failure within a specific area or domain, within a specific region of multiple regions, and within an inter country region spanning two or more countries.

4. The method of claim 1, wherein the failure is a network device failure between the two or more network devices, including a failure of any physical component on the network device that can fail, including failure of one or more of: a line card, a port, a power supply, memory, central processing unit, and hard drive.

5. The method of claim 1, wherein the failure is a link failure including one or more of: a traffic error, a traffic capacity load, a maximum transmission unit (MTU) size, and a fragmentation error.

6. The method of claim 1, wherein the failure is a Virtual Extensible Local Area Network (VXLAN) failure including one or more of: removing virtual tunneling endpoint (VTEP) addresses, deleting a Route Reflector, virtual network identifier (VNI) forwarding functions including deleting Anycast gateway, and removing virtual routing and forwarding (VRF) components.

7. The method of claim 1, wherein the failure is a Domain Name System (DNS) failure including one or more of: changing routing to a DNS server, creating several DNS requests to cause overload of the DNS server.

8. The method of claim 1, wherein the failure is related to a networking technology including one or more of: an encapsulation error; a routing protocol error including database corruption, neighbor failure, adjacency failure, and next hop failure; and Storage Area Network (SAN) protocol failure including storage traffic load, shut down of SAN ports, wrong World Wide Name (WWN), and wrong Logical Unit Number (LUN).

9. The method of claim 1, wherein the failure is related to network security functionality including one or more of: removal of an encryption key, removal of virtual private network (VPN) IP addresses, and failure of security peering to other devices.

10. The method of claim 1, wherein generating the one or more commands comprises specifying values in one or more fields using an in-Situ Operations Administration and Maintenance (iOAM) protocol to indicate the one or more commands provided to the two or more network devices to simulate the failure across the network path.

11. The method of claim 1, wherein obtaining the telemetry data is performed from network traffic populated with the telemetry data as the failure is propagated through the network path.

12. The method of claim 1, wherein obtaining the telemetry data is performed via a separate out-of-band communication to the network controller from the two or more network devices.

13. The method of claim 1, further comprising:
changing a configuration of one or more of the plurality of network devices based on the analyzing of the telemetry data.

14. An apparatus comprising:
a network interface that performs network communications, including communications with network devices in a network;
a memory;
one or more processors coupled to the network interface and the memory, the one or more processors configured to perform operations including:
generating one or more commands that are configured to inject a failure to propagate through two or more network devices of a plurality of network devices in the network;
providing the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices;
obtaining the telemetry data collected from the two or more network devices; and
analyzing the telemetry data to determine an impact in the network of the failure propagated through the two or more network devices,
wherein generating the one or more commands comprises specifying a collection type in a collection type field of an in-Situ Operations Administration and Maintenance (iOAM) protocol as one of end-to-end network path collection and single node collection.

15. The apparatus of claim 14, wherein the one or more commands are configured to:
inject the failure through the two or more network devices that are in an end-to-end network path between a source node and a destination node in the network; and/or
inject the failure within a specific area or domain, within a specific region of multiple regions, and within an inter country region spanning two or more countries.

16. The apparatus of claim 14, wherein the failure is a network device failure and/or a link failure between the two or more network devices.

17. A system comprising:
a plurality of network devices in a network, each of the plurality of network devices configured with a failure probe function; and
a network controller configured to be in communication with the plurality of network devices, the network controller configured to:
generate one or more commands that are configured to inject a failure to propagate through two or more network devices of the plurality of network devices in the network;
provide the one or more commands to at least one of the two or more network devices to initiate the failure, wherein the one or more commands cause the failure to propagate through the two or more network devices and cause the two or more network devices to collect and propagate telemetry data, on a hop-by-hop basis, from the two or more network devices as the failure propagates through a network path that includes the two or more network devices;
obtain the telemetry data collected from the two or more network devices; and
analyze the telemetry data to determine an impact in the network of the failure propagated through the two or more network devices,
wherein generating the one or more commands comprises specifying a collection type in a collection type field of an in-Situ Operations Administration and Maintenance (iOAM) protocol as one of end-to-end network path collection and single node collection.

18. The system of claim 17, wherein the one or more commands are configured to:
inject the failure through the two or more network devices that are in an end-to-end network path between a source node and a destination node in the network; and/or
inject the failure within a specific area or domain, within a specific region of multiple regions, and within an inter country region spanning two or more countries.

19. The system of claim 17, wherein the failure is a network device failure and/or a link failure between the two or more network devices.

20. The system of claim 17, wherein the network controller is further configured to change a configuration of one or more of the plurality of network devices based on analysis of the telemetry data.
